(19) United States
(12) Patent Application Publication
(10) Pub. No.: US 2013/0110513 A1
(43) Pub. Date: May 2, 2013

(54) Platform for Sharing Voice Content

(71) Applicants: Roshan Jhunja, New York, NY (US); Gina Renaldo, New York, NY (US); Sylvia Ng, Middle Village, NY (US); Danny Chan, New York, NY (US); Adrianna Desier Durantt, New York, NY (US); Tauseef Chohan, Stewart Manor, NY (US)

(72) Inventors: Roshan Jhunja, New York, NY (US); Gina Renaldo, New York, NY (US); Sylvia Ng, Middle Village, NY (US); Danny Chan, New York, NY (US); Adrianna Desier Durantt, New York, NY (US); Tauseef Chohan, Stewart Manor, NY (US)

(21) Appl. No.: 13/281,832

(22) Filed: Oct. 26, 2011

(51) Int. Cl. G10L 11/00

(52) U.S. Cl. 704/270.1; 704/E11.001

(57) ABSTRACT

Methods for providing access to voice content are provided. For example, voice content is accessible to a plurality of users employing a platform in which inputting, outputting, searching, processing and transacting are facilitated in a manner uniquely suited to voice content. Such a platform may isolate characteristics specific to voices for purposes of ranking, grouping, gaming, translating, teaching or studying.

### CROSS-REFERENCE TO RELATED APPLICATIONS

U.S. Pat. No. 6,353,823, Issue Date Mar. 5, 2002, Method and system for using associative metadata
U.S. Pat. No. 7,571,099, Issue Date Aug. 4, 2009, Voice synthesis device
U.S. Pat. No. 5,832,499, Issue Date Nov. 3, 1998, Digital library system
U.S. Pat. No. 7,844,604, Issue Date Nov. 30, 2010, Automatically Generating User-Customized Notifications of Changes in a Social Network System
U.S. Pat. No. 5,652,828, Issue Date Jul. 29, 1997, Automated Voice Synthesis Employing Enhanced Prosodic Treatment of Text, Spelling of Text and Rate of Annunciation
Application Ser. No. 10/473,432 Filed Apr. 9, 2004, Sound characterisation and/or identification based on prosodic listening
Application Ser. No. 12/987,788 Filed Jan. 10, 2011, System and Method to Facilitate Real-Time Communications and Content Sharing Among Users over a Network

### BRIEF DESCRIPTION OF THE SEVERAL VIEWS OF THE DRAWING

FIG. 1

Referring to FIG. 1, the system receives input 100. Input may include a plurality of sources. Sources can be categorized as public and private repositories, dialogue, and query or request. System processes data 102 through by analyzing, filtering and storing. The system allows for transactions 104. A decision is made whether to transact or not to transact. If the decision is not to transact 106, the process ends. If the decision is to transact, the process continues to create output 108 based on request.

FIG. 2

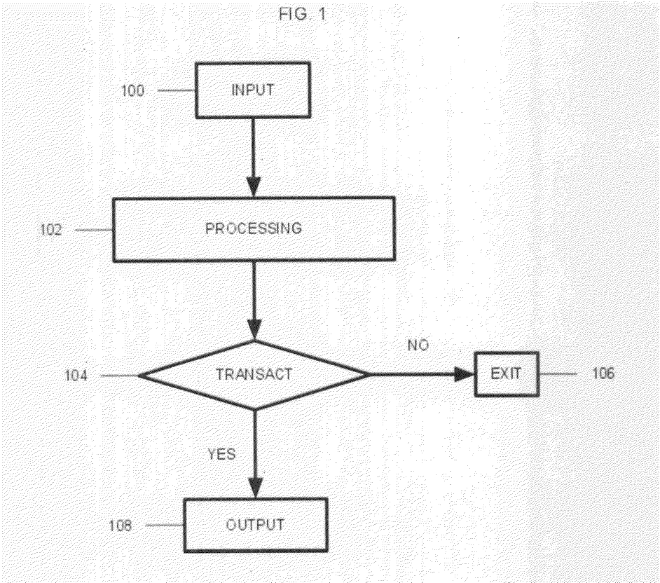

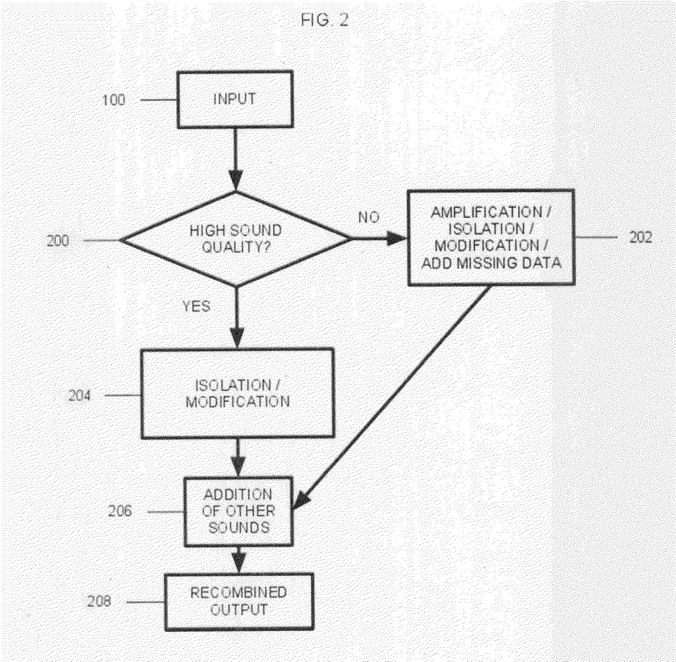

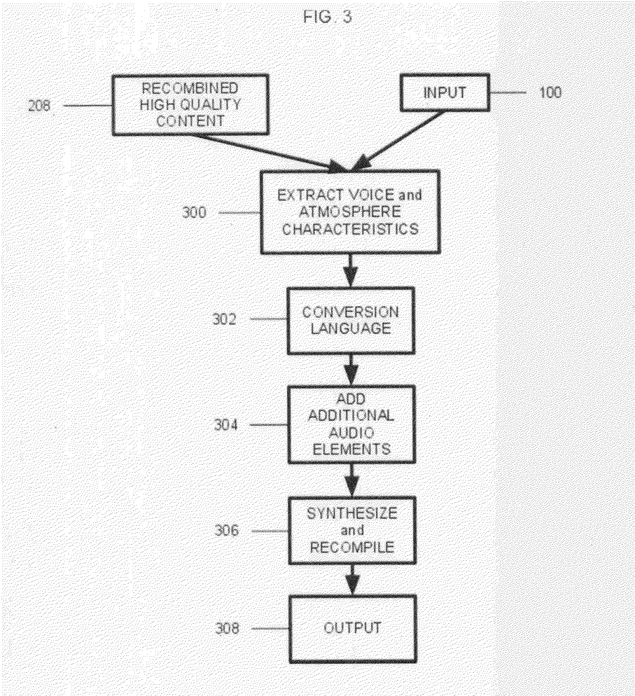

Referring to FIG. 2, the system receives input 100. The system decides if the input 100 data content is of high quality 200. If the input 100 is of low quality, the system proceeds to process 202. The process in 202 may comprise at least one of amplification, isolation, modification, and the addition of missing data elements. Isolation may include at least one of extraction and identification. If the input 100 is of high quality, the system proceeds to process 204, which comprises of isolation and modification. Isolation may include at least one of extraction and identification.

After processing, the system and the user may proceed to add-in additional data elements 206. After process 206, the data elements get recombined 208.

FIG. 3

Referring to FIG. 3, the system receives input 100 and recombined high quality data elements 208. The process of extraction 300 breaks down the data elements that the system receives into at least one of the following: pitch, tone, frequency, atmosphere, accent and range. The process of conversion 302 comprises of the ability to translate language from one to another. The process provides the ability to add-in additional audio elements 304. The system provides the opportunity for the user to fine-tune content 306. The system provides output 308.

### DETAILED DESCRIPTION OF THE INVENTION

The following sections I-X provide a guide to interpreting the present application.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

A reference to “descriptive element” or “descriptive characteristic” refers to information which can characterize, define or otherwise imply known details about an object, for example the “voice data” stored on the platform described by the present application.

The terms “including”, “comprising” and variations thereof mean “including but not limited to”, unless expressly specified otherwise.

The terms “a”, an and “the” mean “one or more”, unless expressly specified otherwise.

The term “plurality” means “two or more”, unless expressly specified otherwise.

The phrase “user interacting with content” and variants of it refers to a variety of abilities provided by the platform referred to in the present invention, to users of the platform or systems accessing the platform. For example, interactions with content may include ranking, rating, playing, uploading, downloading, streaming, and other modes of effecting reciprocal action as described in various embodiments in the present application.

The term “herein” means “in the present application, including anything which may be incorporated by reference”, unless expressly specified otherwise.

The phrase “at least one of, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of, when such phrase modifies a plurality of things does not mean “one of each of the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The terms “enhancement”, “high quality” and other like terms refer to a relative assessment of overall quality which is better than some average or comparison point. Similarly the term “low quality” refers to a relative assessment of overall quality lower than some average or comparison point. These qualitative assessments are not understood to be incontrovertible and may originate from a variety of sources including voting results, expert opinion and automated assessment using computer algorithms or sensors.

The term “re-purpose” and like terms indicate that something has been employed in a new usage, context or application which differs in some way from its original usage, context or application.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article the to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples and Terminology are Not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim. The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases or repositories are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of or the phrase “steps of in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### IX. Incorporation by Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution hi story of the present application, but not to the prosecution history of any other patent or patent application, regardless of whether there are other patent applications that are considered related to the present application, and regardless of whether there are other patent applications that share a claim of priority with the present application.

### XII. Disclosure

This disclosure describes a method for receiving voice content and making it available to a number of users and systems for a variety of purposes. Voice content may include direct recordings of human voices speaking or otherwise vocalizing, or electronically-synthesized content which uses one or more human voice recordings as a basis. In the present invention the term ‘vocalizer’ will refer to the person or system emitting or originating the voice content and can include one or more persons or systems.

The platform employed to receive and provide access to the voice content may be embodied in a number of different approaches including hosting on one or more servers for use on a network such as the Internet, or a distributed model wherein storage, computation and input/output are provided by a plurality of interconnected devices often known as a ‘cloud’.

The platform will employ some mechanism for utilizing information about its users. One approach might be to allow for the creation and maintenance of a user ‘profile’, wherein users are able to enter both demographics and uniquely identifying information, set preferences and store other information about themselves for use by the platform itself or by other users. Information about users may alternatively be supplied by, or supplemented from, a separate social network or similar platform already containing information about the user, in which case the user may or may not be required to enter authentication information in order to link the information from one platform to the other.

Inputs to the platform may come from a variety of sources including audio-recording devices with networked capabilities, storage devices or computer-readable media, distinct media platforms, media repositories comprising digitalized audio and video or live broadcasts containing audio information. Inputs may consist of receiving or referencing distributed voice content accessible by networked systems, or involve processes by which voice content is extracted, synthesized or distilled from a variety of media sources. Inputs may also originate from pre-existing content on the platform through processes such as subdivision, merging, extraction, synthesis or recombination.

The platform will maintain a metadata repository of descriptive characteristics for voice content it contains. This metadata may include information about the user or system that uploaded the voice content, the vocalizer of the voice content, the location, setting or conditions of the creation of the content, or characteristics deemed to be present in the content such as mood, tone, volume, pitch, speed, language, national or regional accent, or emotion. Metadata may involve unique media identifiers such as watermarks or other techniques used in digital rights management, ranking within certain categories, established for purposes of grouping or otherwise classifying voice content according to dimensions such as gender, age, race or vocalizer's ethnic or geographic origin. The words, phrases and other vocal content present may be metadata, with or without a corresponding time index of when they are each vocalized within the voice content. Additional metadata may also include the type of content and subject matter, for example a speech, an argument, a phone call or a radio broadcast. Metadata may be supplied in connection with the input process or provided in subsequent platform use including automated assessment by algorithms, assessment by one or more users such as reviewing, tagging or rating, aggregated statistics over time such as number of downloads or ‘listens’ (plays), or relative ranking in a given category based on input from other users.

Voice content may be located on the platform using a variety of mechanisms including browsing by established categories, searching or filtering against metadata associated with voice content in the platform, linking internally or externally using unique content identifiers or by receiving a recommendation from another user or the platform itself. Searching and filtering may involve providing the platform with one or more words, images, voice content elements or other multimedia content.

Once located, voice content may be output in any number of ways such as a streaming preview comprised of a part or the entirety of the voice content, a file download containing the voice content, an ongoing stream of one or more voice content elements, a composition involving voice content from the platform mixed with video, audio or other multimedia content from a separate source, electronically synthesized or transformed voice content, or delivery to a separate electronic system of the voice content requested.

The platform may facilitate a number of options for transaction on voice content, including licensing, leasing, auction, loan or exchange agreements or complete rights transfers for fixed amounts of time or perpetuity. The facilitation may involve a provided communication channel for users to negotiate a transaction, or the platform may accept a set of parameters governing user preferences with respect to permitted transaction types, terms and amounts for purposes of automating one or both sides of the transaction.

### Device Voice Selection

In one embodiment, the platform may be used to supply different voice selections for mechanical or electronic devices such as spoken voice turn-by-turn applications present in today's GPS (Global Positioning Service) navigation devices, Interactive Voice Response units (IVRs) utilized in telecommunications applications, or any other application in which a mechanically generated voice is utilized. In this embodiment, users would be able to specify voice criteria for the platform to use in selecting a voice or users could browse or search the platform to choose a voice to employ. Once a selection is made by the platform or a user, the selected voice would be utilized by the device from prior recordings, streaming output or real-time synthesis,

### Ad Voice Selection

In another embodiment, advertisers could use the platform to assess voice preferences among their target audiences and use that information to select certain voices, actors or other voice over creators that may be deemed more persuasive by their target audience. Assessing voice preferences could be accomplished in any number of ways including requesting users to rank predetermined voice samples or using data gathered by the platform in the creation of a user profile and in the course of user activity to determine which voices the user responds favorably or unfavorably to. The advertiser could use the assessment findings in the production of advertising material or content. Alternatively advertisers as users of the platform could employ the platform to auto-select in the course of output, an appropriate voice selection based on the user receiving the advertisement. In such an embodiment, control over which voices are used to convey advertisements could be based on advertiser input, recipient input, or combination of the two.

### Searching

Searching for content is a commonplace feature in many existing websites and platforms, and may be implemented in various ways. An embodiment of the present invention might include a search function capable of matching search keywords, in whole or in part, against all of the descriptive characteristics maintained within the platform. An embodiment might also feature a mechanism allowing for alternative inputs to the search process, such as a voice recording or video which may require interpretation such as speech-recognition in order to find matches against voice content in the platform. In one embodiment, words or phrases present in a given voice content item may have their temporal placement extracted as descriptive characteristics, such that the precise time indexed location of every word or phrase can be searched for. In this type of an embodiment, words or phrases supplied as text or audio input to a search may be located within the listing of search results; presenting users with not only the voice content containing the searched-for terms, but also the indexed location within each search result such that the match is readily accessible and apparent. This type of searching within content may prove advantageous for reducing the time necessary to locate what the user was searching for.

### Dubbing

An embodiment of the invention can be used for translating the dialogue within a film from the original language to a second language while maintaining the authenticity of the dialogue's characteristics such as mood, pitch, and regional accent. In this embodiment the received input could be from a repository of audio and video media. The repository source can be provided interactively by a user of the platform or automatically based on preferences pre-defined by an individual user, film producer, or regional dialects. The received audio and video content may then be processed to produce a high quality audio stream. The high quality audio stream would then be processed to isolate and identify specific characteristics of the dialogue within the film utilizing a plurality of methods. The film's script, voice characteristics of the dialogue, psychological analysis of the dialogue, and background audio could then be utilized to synthesize the dialogue in a second language while maintaining the original voice. This embodiment of the invention greatly benefits film production by providing a method for accurately dubbing dialogue in a film from one language to any second language. This translation can occur during the production, post-production, or during the play of a film. During the production process, the director, actor, and sound editor can fine tune the dialogue to better match the actors' voice characteristics, scene's intensity, and directors' standard. The translated dialogue can then be stored for retrieval by a plurality of methods.

Another embodiment of the present invention can be used to modify the dialogue in a film to substitute or remove objectionable dialogue in streamed and lagged media. This process could utilize the film's script in combination with the dialogue in the film to identify and remove, or substitute the objectionable dialogue with authentically synthesized dialogue. The request for removal or substitution could be initiated by a user of the platform; a parent or guardian.

Yet another embodiment of the invention may be for users to provide voice data content for public and private use. This content may be used for creating new content or searching for a specific voice for various uses (voice talent). The users can also create content for non-professional dubbing of existing audio and video content. One use of this non-professional dubbing can be purely for entertainment. A user can manipulate a voice by changing various aspects of it characteristics from pitch to language.

### Live Script/Dialogue Reading

In another embodiment this invention may be employed to create a spoken draft for a script or dialogue reading as may be practiced in early stages of television, film, stage and animation projects, speech writing, audio broadcasts, podcasts or audio book creation.

In this embodiment a user may utilize the platform to “cast” or employ voices ahead of time as a trial to test for compatibility and provide for efficiency in production. By allowing a user to “trade in” and “trade out” a variety of voices per the needs of a particular production, writers, directors and producers may find a more flexible and efficient way of getting what they need. This usage is particularly valuable in circumstances where the voice doesn't match the orator (e.g. animation projects or for audio purposes where the image is absent). By allowing a user to synthesize the voice content for effect, the user may be able to create a cast of characters or performers, revise work, and edit work accordingly.

### Speech Editing

Another embodiment may include using the platform to allow a speech writer to draft a speech and collect a voice sample from the intended speech maker to synthesize a spoken draft which may be valuable in the process of editing. This embodiment may also permit users to share voice and video content of themselves practicing or delivering a speech or presentation for the purpose of requesting other users to rate their performance or comment on factors such as believability, engagement or pace of delivery.

### Voice “Normalizer”

In another embodiment, the platform may provide the ability to “normalize” the voice of a person who may have an aliment such as a sore-throat. An example of this use could be during a live speech from the Chief Executive Officer of a company. The platform could modify and normalize the streamed live voice content to filter the aliment heard in the voice. The voice can further be processed to produce higher quality audio output. The benefits of improved audio quality by normalizing the speech of the presenter improve the listener's impression of the speech and the speaker.

### Custom Voice Preferences

In another embodiment, the platform may provide for the customization of the interpretation of a script. Consider a live conference at the United Nations. Since there are so many different countries represented, the user can modify to listen to the speaker, in this case a United Nations Delegate or representative, according to the user's preference of voice descriptor such as a different accent, pitch, range and frequency.

Another example of this usage may be a script intended for podcast or radio broadcast. In either case, the voice data content can be live, streaming or lagged. The platform provides the user the ability to enhance the voice characteristic of the voice data content to those defined by the user preference. It enhances the quality of the voice by adding or removing certain voice data elements. The user is additionally provided a method to add other data elements to a voice whereby the users can modify and personalize what they are listening to. Users in this example, maybe the listener of the podcast or radio broadcast and it also may be the host announcer of the podcast or radio broadcast. Having the ability to modify the voice data content improves and customizes the users' experience for the purpose that the user intends.

### Voice Environments

In another embodiment, the platform could allow a user to add or create an “environment” into a script. One example may be creating an environment within an audio book. The usage of the word “environment” in this case means physical audio conditions or surroundings, such as “she screams” and the user in this case hears a “scream” or in another example, “he mumbles”, “they chatter”, “she whispers”, etc. The voice file becomes a part of the environment.

The user may also be able to customize or modify the type of voice that they would like to hear the audio book read in, such as a “southern belle accent female” voice. In all cases, the voices have the ability to process an original piece of voice content and convert it into high quality. The voice data elements in this example may be added or removed to make this conversion possible.

Voice Environments may be applied anywhere a soundscape is desired. This may include but is not limited to audiobooks, podcasts, radio and television programming, movies, advertisements, and games.

### Enhancements

The platform may be used to process the voice content it contains, either in real-time during input or output or against pre-recorded voice content. Processing may involve a human, electronic device or computer algorithm and may consist of parsing words and phrases, removing or adding background sounds, removing or adding other voice content, using voice content as a basis for synthesizing new voice content or otherwise altering the character and qualities of voice content to suit a particular purpose.

In one embodiment, the platform is used to translate a discussion in real time. Each participant may speak in the language of their choice, and select a language of their choice for responses. The platform acts as the intermediary, accepting any language and parsing the language by dialect and dialogue. By breaking down the discussion into components, another language can be reformulated and outputted, while the dialogue is universal and maintains the meaning of the discussion. A dialect or accent may be employed based on users' selected preferences. The platform may allow language, dialect and accent selections to be made once or switched multiple times throughout the course of the discussion. In addition, the platform can be used in a lagged time basis to replay the discussion in different language variations.

In another embodiment, a discussion can be enhanced using the platform. For a broadcast or recording subject to signal loss or other degraded quality characteristics, the platform can be employed to parse the dialogue and refine the content. In this manner low quality voice content may be improved into resultant high quality voice content. For words that are inaudible or muffled, the platform may employ various methods to predict and insert appropriate words. For words deemed too loud or quiet, the platform can correct to the desired volume. For desired changes to the content of dialogue, the appropriate words can be synthesized and output in the appropriate location.

In another embodiment, a computer system can use the platform to perform the conversation. In a scenario where commands can be issued to a computer system, the platform can provide appropriate commands based on voice inputs. Alternatively a computer system can be involved in a discussion between humans such that the computer is capable of contributing vocalized information in response to questions asked in the discussion and directed towards the computer from other users. In both instances, the platform creates the common language for a conversation to occur.

### Entertainment

There are any number of additional commercial and non-commercial embodiments serving primarily as entertainment for users. Games could be created based on matching voice samples with photographs or video, users may search to locate voices that resemble their own, select voices located through the platform to create personal voice mail greetings or to leave messages for others, or apply voice enhancement or synthesis filters to a provided piece of voice content to hear their own voice with any number of characteristics applied such as a selected accent, a selected language, a selected pitch or a selected mood.

### Recognition & Reference

In one embodiment, similar to that of a Shazaam model, users may speak into a recording or transmitting device such as a smartphone or personal computer as an input for the purpose of locating their spoken word or phrase within the collected voice content accessible on a platform. In such an embodiment the platform would employ voice recognition or similar technology to collect and identify the words or phrases spoken and compare them with the words or phrases present within all voice content located on the platform. The search method can be similar to Boolean search to find specific contents or by groups of words for a close match. Inputs are compiled to develop a history of terms to refine future searches and recommendations.

Additional criteria such as the volume, pace, accent, language, pitch or relative emphasis of the spoken input could refine the results of the search. Users might expect to see results including dialogue from specific scenes in specific movies, famous speeches, interviews or news broadcasts. Results might also include matching text from reference documents such as dictionaries, encyclopedia and thesaurus', popular literature, periodicals and books, or websites and social media content.

### Data Mining

In one embodiment advertisers or researchers may employ the platform for collecting usage statistics such as the keywords or inputs most often used to search, aggregate characteristics or demographic information from users of the platform, aggregated statistics on the people uploading voice content or the people or systems vocalizing within the voice content. Such information may be advantageous for targeting advertisements to specific audiences deemed valuable for marketing purposes, or for academic or corporate research on trends in various populations.

### Vocal Training

In another embodiment the platform may be used to facilitate various training exercises. In one scenario a user desiring to improve their skills in a specific language, accent or dialect may input recordings or live streams of words and phrases for review by other users of the platform. Other users may include experts in the language, accent or dialect, who may provide comments and feedback on the qualities of the input either on a paid or unpaid basis. Alternatively, all users of the platform or known associates or friends of a specific user may be invited to comment and rate the quality of the voice content that this user provides. Rating or judging such content may be in the form of a game, where users are asked to identify the language, accent or dialect employed in a supplied piece of voice content for which these attributes are hidden or unknown.

Alternatively, computer algorithms may be employed to assess supplied voice content. Such algorithms may employ one or more ‘reference’ voice content samples as a basis for comparing the accuracy or relative quality of the voice content under review.

### Stock Marketplace

In this embodiment, similar to a Getty and Corbis model, the platform may be used to connect voice content providers to voice content consumers. The platform would provide a marketplace of “stock” voice content for users to transact upon. “Stock” in this embodiment refers to the supply of stocked or inventoried voice data that may be available for immediate sale or distribution. Other transactions may include but not limit to acquisition of rights to voice content, permissions to share, license, lease, and purchase. The stock catalogue may consist of both licensed and non-licensed voice content. This embodiment also allows for the request of voice content such as a “soft whisper” or a “fast talker saying ‘Get me to the bakery!’”

### Author's Voice Representation

This embodiment would enable an author to use this platform to search, select and obtain a particular voice to represent the content they would publish. For example, there may come a time where the NY Times allows the option for a reader to hear each published article. The author of each article may have the ability to have their voice represented by a voice other than their own. They would be able to use the platform to find their desired match per the content. Paul Krugman may decide that he wants his articles to be read from the voice of a woman, someone that sounds similar to his wife. Helene Cooper may discover that for recording audio, she has a terrible stutter and may want her voice represented by someone's who's match is as similar to hers as possible. Another author may desire to be represented by someone who can supply a more enticing delivery than they could on their own. The platform would be able to provide for these desires.

This disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method comprising:
providing a platform accessible by a plurality of users, wherein the users can interact with voice content by:
receiving from one user at least one of voice content;
processing received voice content at the request of a second user;
allowing users to search for voice content;
allowing users to browse the platform for voice content;
outputting the data to a plurality of users upon their request;
providing users with an ability to transact on voice content.

2. The method of claim 1, wherein the processing of voice content comprises:
allowing at least one of the voice content to be enhanced;
allowing at least one of the voice content to be modified with further contents.

3. The method of claim 1, wherein the platform employs the preferences set by a user to automate:
receiving voice content;
processing of voice content;
searching of voice content;
outputting of voice content.

4. The method of claim 1 wherein users are able to interact with at least one of unprocessed and processed voice content.

5. The method of claim 1 wherein the users can utilize the platform to output at least one of lagged and streaming voice content.

6. The method of claim 1 wherein the platform employs the descriptive elements of voice content in a search process to locate and provide the precise location of words, phrases or other vocalizations identified as present within voice content.

7. A method of processing or re-purposing voice content involving at least one of:
enhancing at least one of voice content by employing a plurality of other media sources;
adding or removing elements from voice content to create derived voice content.

8. The method of claim 7, wherein the sources may include at least one of public and private repositories.

9. The method of claim 7 wherein the process of enhancing comprises of at least one of identifying, tagging, correlating, associating, categorizing and grouping descriptive elements of voice content.

10. The method of claim 8, wherein the data can consist of at least one of human and system input.

11. The method of claim 7, wherein the enhancing process employs at least one of the following approaches: using existing voice content for the purpose of creating new voice content: extracting, synthesizing, isolating, filtering and adding one or more missing components.

12. The method of claim 7, wherein the enhancing may include: mixing, matching or recombining to produce modified voice content.
